(19) United States
(12) Patent Application Publication
(10) Pub. No.: US 2021/0036282 A1
(43) Pub. Date: Feb. 4, 2021

(54) UPPER COVERING PART FORMING A LID FOR BATTERY HOUSING FOR AN ELECTRIC VEHICLE

(71) Applicant: Autoneum Management AG, Winterthur (CH)

(72) Inventors: Wilfried JUNGHANS, Frauenfeld (CH); Jeremias SCHÜRMANN, Zurich (CH)

(73) Assignee: Autoneum Management AG, Winterthur (CH)

(21) Appl. No.: 16/982,655

(22) PCT Filed: Mar. 29, 2019
(86) PCT No.: PCT/EP2019/058074

§ 371 Date: Sep. 21, 2020

(30) Foreign Application Priority Data
Apr. 5, 2018 (EP) 18165918.6

(51) Int. Cl. H01M 2/10; B60L 50/60

(52) U.S. Cl. CPC H01M 2/1094; H01M 2/1077; B60L 2270/147; H01M 2220/20; B60L 50/60

(57) ABSTRACT

A battery cover for the housing of a battery pack for a battery electric vehicle comprising at least a thermoplastic carrier shaped to form the covering lid characterized in that the outer surface of the covering lid not facing the battery pack is coated on the outer surface of the covering lid with a conductive paint comprising conductive metal or metal-coated particles and whereby the assembly of the thermoplastic carrier and of the coating has an electromagnetic shielding effectiveness of at least 50 dB, preferably at least 60 dB according to ASTM D4935-10.

This application is a national stage application under 35 U.S.C. 371 and claims the benefit of PCT Application No. PCT/EP2019/058074 having an international filing date of Mar. 29, 2019, which designated the United States, and which claimed the benefit of European Patent Application No. 18165918.6, filed Apr. 5, 2018, the disclosure of each of which are incorporated by reference herein.

### TECHNICAL FIELD

The present invention is related to a novel lid or cover for housing suitable to comprise multiple electrical power cells in electrically driven automotive vehicles, in particularly for housing placed underneath the vehicle.

### BACKGROUND ART

In general a battery pack housing assembly used in an electric vehicle typically comprises a battery pack consisting of a power cell or power cells, a battery management system, a blower, an upper cover, a lower housing, structure reinforcement members, and is mounted underneath the car to the bottom of the vehicle body.

Housing comprising multiple of electrical power cells in motor vehicles are usually necessary to protect the electrical power cells arranged inside from outside influences. Vice-versa the housing is suitable as well, to protect any persons sifting in the car from any influences originated from the electrical power cells inside the housing. Such housing comprises a lower part and an upper part that fit together to create a hollow space, whereby the lower part is containing the battery cells and the upper part is forming the lid.

The lower part of the housing and the reinforcement members as well as the upper part may be made of a steel enclosure to endure the load of the battery. Due to the thick steel needed for stiffness and durability the battery pack housing assembly is heavy. The battery pack housing assembly is typically mounted on a vehicle floor panel, and thus requires chipping resistance, water tightness and corrosion resistance.

The object of the present invention is to obtain a novel light weight upper housing part or lid structure that fits with a lower housing part to form a battery housing and that is able to shield electromagnetic waves.

### SUMMARY OF INVENTION

Said object is achieved by an upper covering part forming a lid for battery housing and a by a battery housing comprising the novel covering part.

In particular by an upper covering part comprising at least a thermoplastic carrier layer shaped to form the covering lid, and a conductive resinous coat comprising conductive metal or metal-coated particles, and whereby the assembly of the thermoplastic carrier and of the coating has an electromagnetic shielding effectiveness of at least 50 dB, preferably at least 60 dB, at RF frequencies between 1 kHz and 1.5 GHz according to ASTM D4935-10 on the outer surface of the covering lid.

The conductive metal or metal-coated particles are preferably silver, silver-plated aluminium, silver-plated copper, silver-plated glass, nickel, zinc, nickel-graphite, copper, steel or aluminium or combinations thereof. Most preferably are silver or silver coated particles or nickel or nickel coated particles.

The carrier layer comprises one of polyamide, polycarbonate, acrylonitrile butadiene styrene (ABS), polyolefin, such as polypropylene (PP) or polyethylene (PE), or polyester, such as polyethylene terephthalate (PET) or any mixture thereof.

The carrier is preferably filled with fillers, such as glass fibers or reinforcement fibers to further enhance the stiffness of the part and or the crash resistance of the material. The carrier might instead also comprise a metal wire net or grid to enhance the stiffness and increase the shielding.

Furthermore, the carrier layer may comprise a composite material where fillers, fibers or textiles are added as reinforcement to the carrier material. These reinforcements may be composed of glass, carbon, aramid, or other synthetic fibers as well as natural fibers to improve.

The thermoplastic carrier material might further comprise a flame retardant additive.

Preferably the carrier layer comprises thermoplastic material from a recycled or reclaimed source either as part of the matrix of the material or as filler content.

The carrier layer is preferably made of thermoplastic sheet material that is formed in a thermoforming and/or vacuum forming process, to obtain the final shape.

The carrier layer can comprise additional design features like ribs to further enhance the stiffness of the part or it might have shapes to provide space for additional appliances like cooling ducts, wires and cables.

It is important that the conductive coating is provided at the surface that is not facing the battery pack or power cells; any flaking of the conductive coating might interfere with the batteries or the electric connection of the batteries.

The conductive metal or metal-coated particles comprised in the conductive resinous coating are preferably silver, silver-plated aluminium, silver-plated copper, silver-plated glass, nickel, zinc, nickel-graphite, steel or aluminium or combinations thereof. Most preferably are silver or silver coated particles or nickel or nickel coated particles. The electro-conductivity is dependent on the type of particles chosen as well as the density of the particles within the layer, and the thickness of the layer. Finer particles are preferred.

Preferably the part containing the conductive coating has at least an electromagnetic shielding of 50 dB, preferably at least 60 dB, at RF frequencies between 1 kHz and 1.5 GHz according to ASTM 4935-10. Preferably the electromagnetic shielding is between 60 and 100 dB at RF frequencies between 1 kHz and 1.5 GHz.

Preferably the coating is based on an acrylic binder resin binding the particles together to form an even coat or film on the outer surface of the carrier layer forming the upper covering part after drying and or curing of the coat. For instance the coat may be applied in the form of a sprayed paint. The thus formed coated layer on the carrier surface is durable, smooth and has both cohesive and adhesive strength towards the carrier surface.

Preferably the thickness of at least the conductive layer is between 20 and 150 μm, preferably between 25 and 125 μm, more preferably between 25 and 100 μm.

For instance a conductive coating comprising silver plated copper particles in an acrylic based coating with a density of 0.6 (g/cm³) and a thickness of 50 μm is having a shielding of 60-65 dB at RF frequencies between 1 kHz and 1.5 GHz. A comparable coating with a density of 1.3 (g/cm³) is having the same shielding potential already at 25-30 μm. The thickness of the coating can be varied to increase the shielding on those areas that are facing the passenger and or sensitive electric equipment. Preferably the coating is having a variable thickness over the surface of the upper cover according to the invention.

Covers for battery boxes might be complex shaped, to incorporate any coverage for appliances and channels needed for the functioning of the batteries within the box and stored with the battery packs inside the battery box. This might also include cooling systems and wiring. This can mean that the cover is shaped including flat areas as well as complex 3D shaped areas. It might be beneficial to combine laminated conductive foils or films with the conductive coating according to the invention. The carrier layer can be moulded directly with the conductive film or foil only placed in the flatter areas where the film or foil is not stretched enough to fail its conductive function, while the conductive coating is applied at least in the areas not covered by the foil. Preferably the coating is at least partially overlapping with the foil so that the conductive surface is substantially intact, as each breach of the conductive surface will increase the electromagnetic radiation that can pass the part and reach the passengers and or interfere with other electrical appliances.

Preferably at least one of a metal foil preferably copper, aluminium, nickel or steel foil is used, more preferably an aluminium foil is used. Preferably the foil thickness is between 20 and 100 μm. By combining conductive foil with a conductive coating, the foil can be restricted to the flatter areas and therefore is less stretched during the production of the part. Hence thinner foils can be used, saving material and weight.

Alternatively, a conductive thermoplastic film or foil comprising electro-conductive particles can be used.

The carrier layer may be treated to further improve the resistance of the coating to delamination or flaking. For instance, an undercoating may be applied to the surface of the thermoplastic carrier before the application of the coating. As an undercoating preferably one is used that lightly etches the surface of the carrier to enhance the binding of the conductive layer to the carrier layer.

To increase the abrasion resistance an additional protective layer may be applied on top of the conductive coating. This may enhance the resistance of the surface layer against scratching and chipping. The protective coating may be a coating of polyurethane, either clear or containing colour pigments or dyes.

The undercoating layer and or the protective layer preferably comprise of a thermoplastic or thermoset coating layer of up to 3 mm, preferably less than 1 mm.

The undercoating layer and or the protective coating layer may be one of a polyurethane formulation, preferably a polyurethane elastomer, a cured epoxy resin formulation, a polyolefin, preferably polypropylene or polyethylene primer or an acrylic resin formulation or a combination of these.

For instance, a branched polyurethane coating made of a polyurethane formulation comprising a branched polyurethane with a molecular weight between branch points between 1000 and 13000 might be used as a protective and or undercoating layer. Alternatively, a polyurethane elastomeric layer might be used.

Also an epoxy resin coating composition might be used for instance one comprising an epoxy resin containing in the molecule at least 2 epoxy groups and a curing agent composition.

It may also be a self-curable polyepoxy resin composition for instance comprising a polyepoxy resin having an epoxy equivalence of greater than one, a polyamide, salicylic acid and N-(3 aminopropyl)piperazine.

Or any other composition that enhances abrasion resistance and or the hardness of the single layers and/or the laminated layers.

In a separate embodiment the carrier layer is vacuum formed with at least locally a metal foil layer, advantageously in flat areas. For instance, foils like aluminum, steel, copper, chromium or silver or combined foils using more than 1 type of the ones mentioned can be used. In a second step at least in the areas not covered by the metal foil the thus formed part is coated with a conductive paint comprising at least silver particles and or silver-plated copper particles, and whereby the coated surface has an electromagnetic shielding of at least 50 dB, preferably at least 60 dB, at RF frequencies between 1 kHz and 1.5 GHz according to ASTM 4935-10.

Upper covering parts or lids with a carrier layer and laminated thereto a metal foil layer are known in the art, however covering parts can have very complex shapes whereby the metal might have cracks and or unwanted folds in the surface, a combination of using foils in the flat surface areas and a coating according to the invention in combination can ensure that no uncovered areas will exist. Uncovered areas will diminish the effect of the electro-magnetic shielding.

### DESCRIPTION OF EMBODIMENTS

FIG. 1 schematic drawing of a vehicle

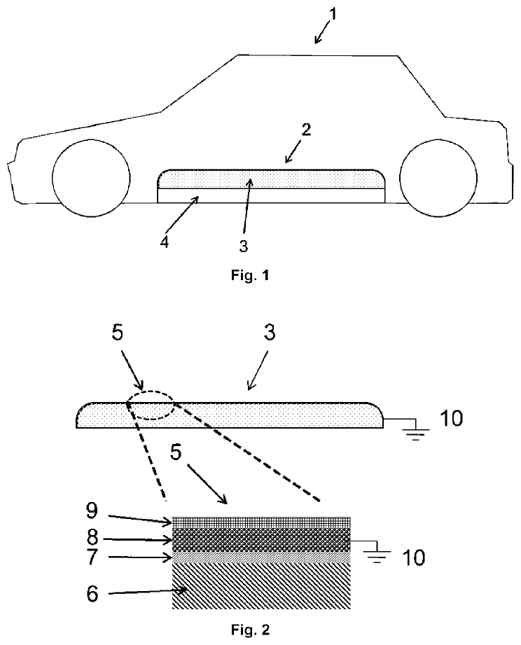

FIG. 2 schematic drawing of a cover for a battery housing

FIG. 2A Cross section through the material layers forming the cover.

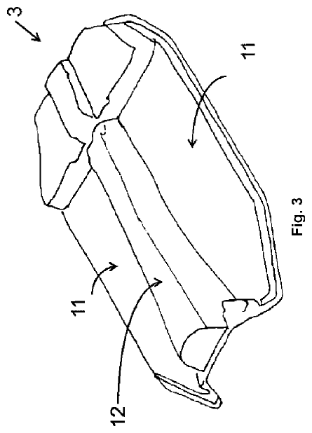

FIG. 3 is showing an example for a cover for battery housing.

FIG. 1 is a schematic drawing of a vehicle comprising at least a battery box or housing 2. The battery box or housing 2 comprises the power cell or cells (not shown) that may be needed for a battery electric vehicle (BEV) or a hybrid electric vehicle (HEV) for instance for electric cars and small people transporting units.

The battery box or housing 2 comprises an upper covering part forming a lid for battery housing 3 according to the invention and a lower part 4 containing the power cell or cells. Both fit together to form an enclosed space for the power cell or cells. Preferably the box is sealed with a sealing at the area of contact between the upper part and the lower part to prevent dirt and water from entering the box and get in contact with the content in particularly the power cells or the connections between the power cells.

Preferably the seal is made of an electro conductive silicone comprising electro conductive particles like for instance silver or silver coated particles or nickel or nickel coated particles, for instance nickel coated graphite.

FIG. 2 is showing the upper covering part forming a lid for battery housing or box in more detail. FIG. 2A is showing a cross section through the material forming the upper covering part. The upper covering part comprises at least a thermoplastic carrier 6 shaped to form the covering lid. The cover is shaped such that it is able to cover at least the open space in the lower part comprising the power cell or cells. Whereby also contours to cover other appliances might be given, for instance to cover additional cooling systems or connections. The battery cover might comprise any ribbing to further increase the stiffness of the cover and or to increase the impact durability.

The outside surface of the upper part forming the covering lid not facing and or not in direct contact with the power cells is coated with a conductive paint 8 according to the invention, comprising at least metal or metal based particles, for instance one of silver particles or silver-plated copper particles and whereby the coated surface has an attenuation of at least 50 dB, preferably at least 60 dB, at RF frequencies between 1 kHz and 1.5 GHz according to ASTM 4935-10.

An undercoating 7 may be applied on the thermoplastic carrier before the application of the coating to further enhance resistance of the coating to external influences like water, sand or salt.

A protective layer 9 may be applied on top of the conductive coating to further enhance the resistance of the surface layer against scratching and chipping. The protective coating may be a coating of polyurethane, either clear or containing colour pigments or dyes.

Preferably at least the conductive layer has an earth connection to achieve maximum shielding performance. For instance, by using a shielding tape or wire, preferably copper, placed within the coating during the application or the earth connection is first applied and over sprayed with the conductive paint. For a functional earth connection, it is important that the wire or tape is also conductive and in direct contact with the conductive layer.

FIG. 3 is showing an example of a cover lid for battery housing with a more complex shape, having a channel on top that may accommodate an integrated cooling system or electric appliances in the battery housing or box. Due to the complex shape it might be advantageous to combine the conductive coating according to the invention in areas that are complex shaped and conductive foil or film in areas that are flat shaped. It might also be an option to cover most of the surface with conductive foil or film while a coat is applied over the entire surface to cover any cracks or gaps in the metal foil cover. For instance, in FIG. 3 the flat areas indicated with 11 might be covered with a metal sheet, for instance a copper or aluminium metal foil, preferably with a thickness of between 20 and 100 μm, while the other areas including the tunnel 12 can be covered with the conductive coating according to the invention.

Example of an upper covering part forming a lid for battery housing according to the invention can be a vacuum formed cover, for instance like FIG. 3 made of polycarbonate with at least a conductive coating comprising silver plated copper particles in an acrylic based coating with a density of 0.6 (g/cm³) and a thickness of 50 μm over the outer surface of the part and having a shielding of 60-65 dB at RF frequencies between 1 kHz and 1.5 GHz.

Upper covering parts forming a lid for battery housing made according to the invention provide not only a good electromagnetic shielding but also an improved resistance to water, salt and dirt coming from the road during driving. Furthermore, in comparison to state of the art covers they have fewer layers and are maintenance free.

1. An upper covering part forming a lid for battery housing for an electric vehicle, comprising:
at least a thermoplastic carrier shaped to form the covering lid, wherein the outer surface of the covering lid not facing the battery pack is coated on the outer surface of the covering lid with a conductive paint comprising conductive metal or conductive metal-coated particles; and
wherein the assembly of the thermoplastic carrier and of the coating has an electromagnetic shielding effectiveness of at least 50 dB at RF frequencies between 1 kHz and 1.5 GHz according to ASTM D4935-10.

2. The upper covering part forming a lid for battery housing according to claim 1, whereby the conductive metal or metal-coated particles are at least one of silver, silver-plated aluminium, silver-plated copper, silver-plated glass, nickel, zinc, nickel-graphite, copper, steel, aluminium, or combinations thereof.

3. The upper covering part forming a lid for battery housing according to claim 1, whereby the paint is an acrylic based paint or a silicone based coating.

4. The upper covering part forming a lid for battery housing according to claim 1, whereby the conductive coating layer has a thickness of between 20 and 200 μm.

5. The upper covering part forming a lid for battery housing according to claim 1, whereby the thermoplastic carrier comprises one of polycarbonate, polyolefin, preferably polypropylene or polyethylene, polyester, preferably polyethylene terephthalate (PET), polyamide or polylactic acid.

6. The upper covering part forming of a lid for battery housing according to claim 1, whereby the material of the thermoplastic carrier is reinforced with fillers, fibers, or textiles to create a composite part.

7. The upper covering part forming a lid for battery housing according to claim 1, further comprising areas covered with an electro-conductive foil.

8. The upper covering part forming a lid for battery housing according to claim 1, further comprising an undercoating between at least the conductive coating and the carrier or a protective coating on at least the conductive coating.

9. The upper covering part forming a lid for battery housing according to claim 1, further comprising means for grounding the conductive layer.

10. A battery box or housing for power cell or cells for a battery electric vehicle, comprising:
a lower part and an upper part that fit together to create a hollow space, whereby the upper covering part is forming a lid comprising:
at least a thermoplastic carrier shaped to form the lid, wherein the outer surface of the covering lid not facing the power cell or cells is coated on the outer surface of the lid with a conductive paint comprising conductive metal or conductive metal-coated particles; and
wherein the assembly of the thermoplastic carrier and of the coating has an electromagnetic shielding effectiveness of at least 50 dB at RF frequencies between 1 kHz and 1.5 GHz according to ASTM D4935-10.

11. The battery box or housing according to claim 10, further comprising a conductive seal between the upper covering part forming the lid and the lower part.

12. A method of making an upper covering part forming a lid for battery housing, according to claim 1, comprising:
thermoforming the covering lid;
spray coating the outer surface thereof with a conductive paint comprising at least one of silver particles, nickel particles or silver-plated copper particles or a mixture thereof; and
drying and or curing the paint, such that the coated surface has an attenuation of at least 50 dB according to ASTM 4935-10.

13. The method according to claim 12, further comprising the step of laminating at least on flatter areas of the outer surface a conductive film or foil such that the conductivity of the film or foil is not impaired during forming of the part.

14. The method according to claim 13, whereby the conductive film or foil is at least partially covered with the conductive paint to obtain a substantially closed conductive layer over the entire outer surface of the cover.

15. The upper covering part forming of a lid for battery housing according to claim 6, wherein the fillers, fibers, or textiles are comprised of natural or synthetic material.

16. The upper covering part forming a lid for battery housing according to claim 7, wherein the electro-conductive foil is an aluminium, a copper, a steel, or a thermoplastic conductive foil.
